(19) United States
(12) Patent Application Publication
(10) Pub. No.: US 2011/0169267 A1
(43) Pub. Date: Jul. 14, 2011

(54) WIND POWER SYSTEM OF VEHICLES

(76) Inventor: Feng-Kuei CHEN, Tainan City (TW)

(21) Appl. No.: 12/684,131

(22) Filed: Jan. 8, 2010

(51) Int. Cl. F03D 9/00; F03B 17/04

(52) U.S. Cl. 290/55; 415/916

(57) ABSTRACT

A wind power system of vehicles includes a box provided with an air entry, an air exit, and a rotator installed in the interior. Fixed at one axial end of the rotator is a generator connected to a rectifier by a lead. The rectifier is connected to a battery, a voltage amplifier and a driving motor. In operation, wind flows through the entry into the box and escapes through the exit as a car is running. While flowing in the box, the wind forces the rotator and the generator to spin. Simultaneously, the generator generates electricity to be stored in the battery after being rectified by the rectifier. The electricity in the battery is then transmitted to and voltage-amplified by the voltage amplifier and then consumed by the driving motor to drive a car to travel.

### BACKGROUND OF THE INVENTION

1. Field of the Invention

This invention relates to a wind power system of vehicles, particularly to one taking advantage of wind force created when a vehicle is running to drive a rotator to spin, enabling a generator to operate to generate electricity that is stored in a battery after being rectified by a rectifier and then voltage-amplified by a voltage amplifier to drive a motor of a vehicle.

2. Description of the Prior Art

That automobiles are essential in our life is undoubted. Commonly, conventional cars are powered by fossil fuel that has a high carbon dioxide emission, not only polluting air but also provoking global warming to threaten ecologically. Although electric automobiles have been being forcefully developed to lower carbon dioxide emission, they can only run depending on power charged in a battery. However electricity stored on the battery may not last long, so the vehicle has to be stopped for the battery to be charged again for a period of time for next running. Moreover, as the power charging stations are not sufficiently established so far, it is inconvenient for the electric automobiles to travel for a long distance. Therefore, the electric automobiles are far from popular to effectively save energy and lower emission of pollutants.

### SUMMARY OF THE INVENTION

The object of this invention is to offer a wind power system able to create electricity consumed by a running vehicle installed with such wind power system.

The wind power system mainly includes a box provided with an air entry located at the front, an air exit formed at the rear side, and a rotator. Fixed at one axial end of the rotator is a generator, which is connected to a rectifier by a lead. The rectifier is consecutively connected to a battery, a charger and a driving motor as well. In operation, wind flows through the entry into the box and escapes through the air exit as a car is running. While flowing in the box, the wind forces the rotator and the generator to spin. Simultaneously, the generator is to generate electricity that is to be stored in the battery after being rectified by the rectifier. The electricity stored in the battery is then transmitted to and voltage-amplified by the voltage amplifier so as to be consumed by the driving motor to drive a car to travel.

### BRIEF DESCRIPTION OF DRAWINGS

This invention is better understood by referring to the accompanying drawings, wherein:

FIG. 1 is a cross-sectional view of a preferred embodiment of a wind power system of vehicles in the present invention; and

FIG. 2 is flow chart of the wind power system of vehicles in the present invention.

### DETAILED DESCRIPTION OF THE PREFERRED EMBODIMENT

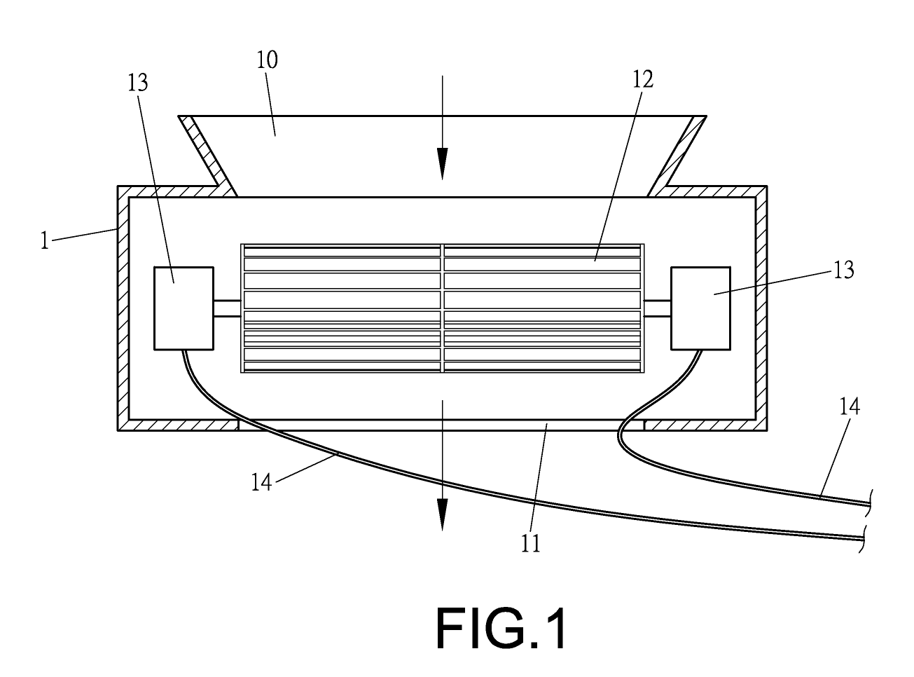

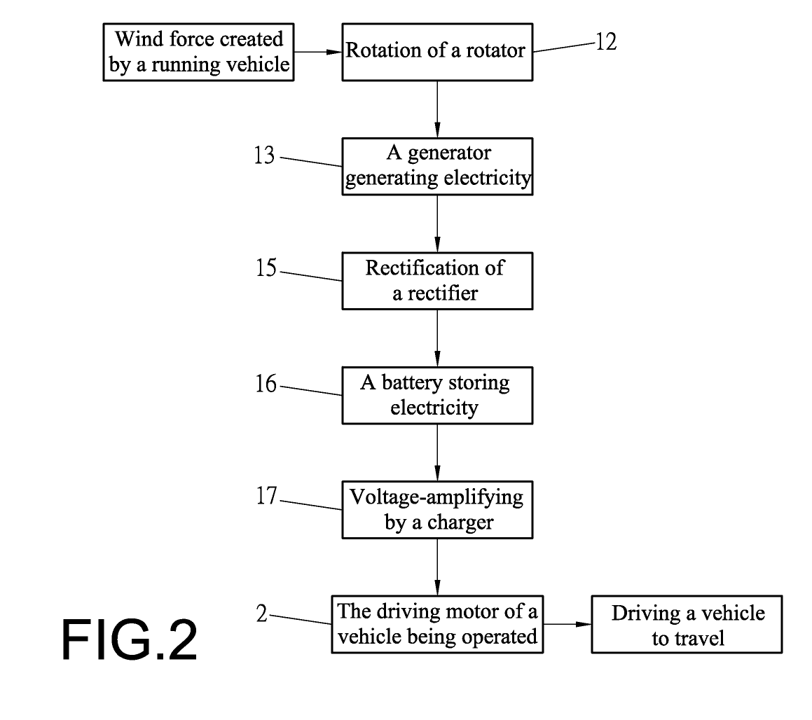

As shown in FIGS. 1 and 2, a preferred embodiment of a wind power system of vehicles in the present invention mainly includes a box 1 installed in a head of a vehicle (such as a motorcycle or an automobile). The box 1 is provided with an air entry 10 located at the front, an air exit 11 formed at the rear side, and a rotator 12 that can be a fan or a blower installed in the interior. Fixed at one axial end of the rotator 12 is a generator 13, which is connected to a rectifier 15 by a lead 14. The rectifier 15 is consecutively connected to a battery 16, which is then connected to a voltage amplifier 17 and a driving motor 2.

In operation, wind flows through the air entry 10 into the box 1 and escapes through the air exit 11 while a car with the wind power system is running, as shown in FIG. 1. While flowing in the box 1, the wind is to force the rotator 12 and the generator 13 to spin, as shown in FIG. 2. Simultaneously, the generator 13 is to generate electricity that is to be stored in the battery 16 after being rectified by the rectifier 15. The electricity stored in the battery 16 is then transmitted to and voltage-amplified by the voltage amplifier 17 so as to be consumed by the driving motor 2 to drive a car to travel. So, as long as a vehicle keeps running, the battery 16 is to be continuously charged to provide power for driving the vehicle, achieving reduction of carbon emission and pollutants.

While the preferred embodiment of the invention has been described above, it will be recognized and understood that various modifications may be made therein and the appended claims are intended to cover all such modifications that may fall within the spirit and scope of the invention.

What is claimed is:

1. A wind power system of vehicles, said wind power system comprising at least a box that is provided with an air entry located at a front, an air exit formed at a rear side of said box, a rotator installed in an interior of said box, one axial end of said rotator being mounted with a generator connected to a rectifier by a lead, said rectifier being consecutively connected to a battery and a voltage amplifier that is further connected to a driving motor, wind keeping flowing through said entry into said box and escaping through said air exit as a car is running so as to force said rotator to spin, said generator then being driven to rotate to generate electricity that is to be stored in said battery after being rectified by said rectifier, electricity of said battery able to be transmitted to and voltage-amplified by said voltage amplifier for being consumed by said driving motor to drive a car to travel.
